(19) United States
(12) Patent Application Publication
(10) Pub. No.: US 2010/0129024 A1
(43) Pub. Date: May 27, 2010

(54) Vending Shim

(75) Inventor: Brent Garson, Orange, OH (US)

Correspondence Address: BROOKS KUSHMAN P.C., 1000 TOWN CENTER, TWENTY-SECOND FLOOR, SOUTHFIELD, MI, 48075, US

(73) Assignee: BIO CLINICAL DEVELOPMENT, INC., Farmington Hills, MI (US)

(21) Appl. No.: 12/324,067

(22) Filed: Nov. 26, 2008

(51) Int. Cl. F16C 33/00

(52) U.S. Cl. 384/626

(57) ABSTRACT

A shim for use in retrofitting a vending machine for dispensing products is provided. The shim has at least two spaced arms each having a first end and a second end, the arms capable of supporting products to be dispensed, and a transverse member joining the arm second ends. The transverse member is arranged to be attached to the vending machine housing such that the arms are disposed in proximity to the dispensing mechanism of the vending machine for dispensing products.

### BACKGROUND OF THE INVENTION

1. Field of the Invention

This invention relates to a shim for use with a vending machine for supporting products to be dispensed.

2. Background Art

Vending machines for dispensing food products and similar articles are known in the art. In particular, helical coil vending machines, or spiral vendors, typically include a housing having multiple shelves, with each shelf having multiple product dispensing lanes. Each product dispensing lane may include one or more elongated helical coils which extend from a back end of the lane to a front end of the lane where products are dispensed. Products to be dispensed are received between the adjacent convolutions of the coils and are dispensed over the front edge of the shelf as the coil is rotated.

Most helical coil vending machines are adapted to dispense products of specific sizes, such as bags of chips, candy, and other items, and the coils and product dispensing lanes are not suitable for dispensing products having other configurations, such as bottles. When vending machines are modified to dispense non-standard products, these modifications are typically permanent, thus eliminating the vendor's flexibility to switch back to vending standard products if desired.

### BRIEF DESCRIPTION OF THE DRAWINGS

FIG. 1 is a top perspective view of a vending shim according to an aspect of the present invention;

FIG. 2 is a fragmentary, perspective view of a vending shim according to the present invention depicting the upstanding portion of the transverse member;

FIG. 3 is an illustration of the vending shim according to the present invention prior to the loading of products and prior to placement in proximity to helical vending coils; and

FIG. 4 is an illustration of the vending shim according to the present invention installed in proximity to the helical vending coils and loaded with products.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

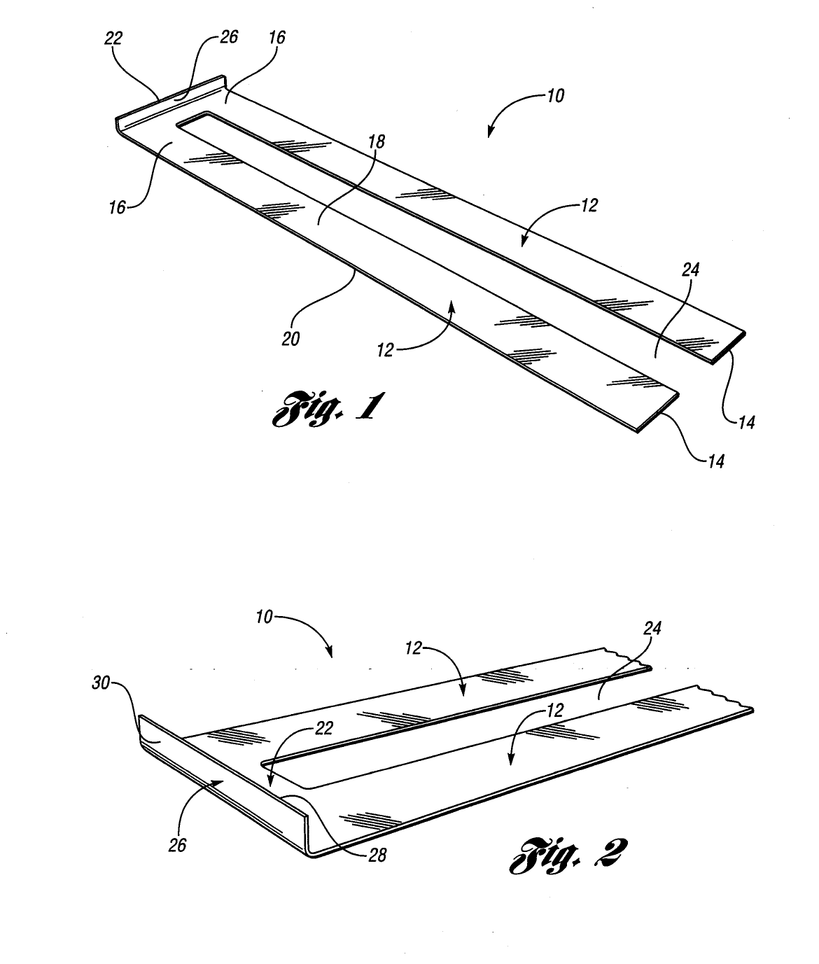

With reference to FIGS. 1 and 2, a vending shim according to an aspect of the present invention is depicted and designated generally by reference numeral 10. The shim 10 may be utilized with a vending machine having a housing and at least one dispensing mechanism, such as a helical coil, for dispensing products. The shim 10 may include at least two spaced arms 12 each having a first end 14, a second end 16, a top surface 18, and an opposed bottom surface 20. According to one aspect of the present invention, arms 12 may be substantially planar and have a thickness of approximately 1-3 mm. However, it is understood that the thickness of the arms 12 is not limited to this range, and also need not be constant along the length thereof. As such, variations in thickness such as, but not limited to, a lesser thickness at the arm first ends 14 as compared with the rest of the arms 12 are fully contemplated. The arms 12 may be elongated and sized to extend substantially along a length of the dispensing mechanism, such as a helical coil, and may be supported thereon. According to one non-limiting aspect of the present invention, each arm 12 may have a length of approximately 55-65 cm and a width of approximately 3-6 cm, although other dimensions of the arms 12 are fully contemplated. The shim 10 may be constructed from a plastic material, although it is understood that other materials are also contemplated.

With continuing reference to FIGS. 1 and 2, a transverse member 22 may join the arm second ends 16. The transverse member 22 may have a length of approximately 12-14 cm and a width of approximately 2-5 cm, but of course is not limited to these ranges. The arms 12 are spaced apart to define an opening 24 therebetween wherein, according to one non-limiting aspect of the present invention, a distance across the opening 24 between the arms 12 may be approximately 3-5 cm. Of course, other sizes of opening 24 are also fully contemplated. The arms 12 are capable of supporting products to be dispensed as described below. As depicted, in this embodiment the shim 10 may have a generally U-shaped, symmetric appearance. It is also contemplated that the shim 10 could have more than two arms 12, in which case the shim 10 would have more than one opening 24. Such a configuration might be useful when the dispensing of more than one product at a time is desired.

The transverse member 22 may include an upstanding portion 26 having a front surface 28 and a rear surface 30. The upstanding portion 26 may have a height of approximately 1-3 cm, but is not limited to these dimensions, and may extend upwardly along the entire length of the transverse member 22 or just a portion thereof. In an alternative embodiment, it is contemplated that the upstanding portion 26 may emanate from each arm 12, with the arms 12 unconnected by any transverse member 22. The shim 10 may be removably attached to the vending machine housing such that the arms 12 are disposed in proximity to the helical coil or other dispensing mechanism for dispensing products. According to one aspect of the present invention, the upstanding portion 26 of the transverse member 22 may be removably adhered to the vending machine housing, such as via an adhesive material on the rear surface 30 thereof.

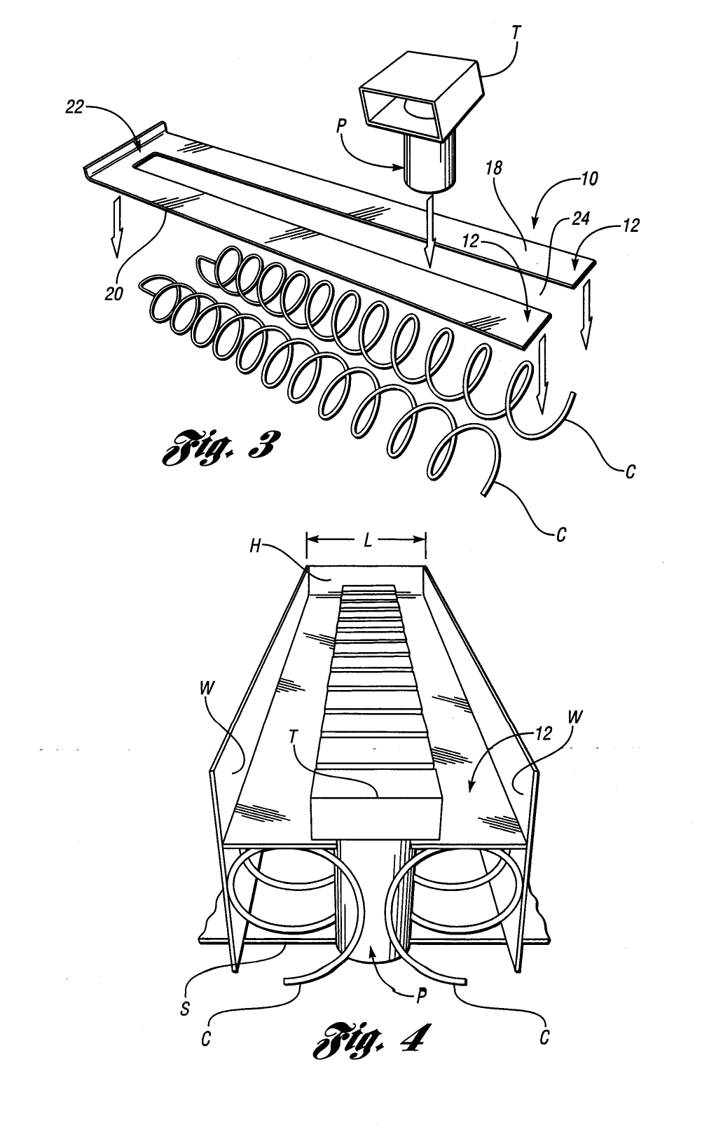

Turning now to FIGS. 3 and 4, the vending shim 10 according to the present invention may be used to support products to be dispensed from a vending machine. Vending machines are known in the art and will be described herein only insofar as is necessary for an understanding of the present invention. With particular reference to FIG. 4, a vending machine typically comprises a housing H having a rear wall and including multiple vertically spaced shelves S, with each shelf divided into multiple product dispensing lanes L by a plurality of side walls W. Each product dispensing lane may include one or more dispensing mechanisms, such as one or more elongated helical coils C which extend from a back end of the lane to a front end of the lane where products P are dispensed. As is known in the art, products P to be dispensed may be received between adjacent convolutions of the helical coils C, where the products are advanced through the convolutions and ultimately dispensed over the front edge of the shelf S upon activation of the dispensing mechanism (e.g., upon rotation of the coil or coils C by a motor).

Most vending machines are adapted to dispense products of specific sizes, such as bags of chips, candy, and other items, and the dispensing mechanisms are not suitable for dispensing products having other configurations, such as bottles. In particular, bottles may tip over, fall between the coils, or rotate such that the product label is not visible to the purchaser. In accordance with the present invention, the products P to be dispensed may be bottles, which may have a base B with a width less than a width of one helical coil C, wherein such a configuration may make it difficult for such products to remain in proper position within the dispensing mechanism for vending. In accordance with the present invention, the products P to be dispensed include at least a portion thereof having a width exceeding a width of the opening 24 between the arms 12, such that the product P may be supported by the arms 12. It may be a portion of the product itself such as, but not limited to, a midsection of the product or bottle cap. Alternatively, the product may include associated packaging having a width greater than the width of the opening 24, such as the topper T depicted in FIGS. 3 and 4.

Accordingly, the present invention provides a method for retrofitting a vending machine to dispense non-standard products, such as bottles. Upon installation, the bottom surface 20 of the arms 12 may be disposed in contact with the dispensing mechanism. In many vending machines, the dispensing mechanism comprises at least one helical coil, and sometimes two adjacent helical coils C. In vending machines with the latter configuration, the shim 10 according to the present invention may be installed such that each arm 12 overlies and is at least partially supported on one of the helical coils C. For single coil machines, the width of the shim 10 may be selected so that the arms 12 both overlie and are at least partially supported on the coil. In addition, although not required, the width of the shim 10 may be selected to substantially span the product dispensing lane L and abut the side walls W. Of course, it is understood that the vending shim 10 according to the present invention is not limited to use with helical coil type dispensing mechanisms or vending machines of a specific configuration.

As illustrated in FIGS. 3 and 4, products may be loaded into the vending machine so as to be supported by the arms 12 and received at least partially within the at least one dispensing mechanism. According to one non-limiting aspect of the present invention, associated packaging T may span the opening 24 and be supported on the arm top surfaces 18. The shim 10 may be attached to the vending machine housing prior to loading the products P. Alternatively, products P may be positioned in the shim 10 prior to attaching the shim 10 to the vending machine housing, such as by loading the products vertically into the opening 24 or by sliding the products into the opening 24 along the arms 12. As shown in FIG. 4, cooperation between the shim 10 and the product dispensing mechanism may keep the products P in an appropriate position for dispensing and in a front-facing orientation for product identification purposes. The dispensing mechanism may then be activated to advance the products past the arm first ends 14 in order to dispense products from the vending machine. In accordance with the present invention, the shim 10 may have certain surface characteristics such as, but not limited to, a smooth bottom surface 20, such as for facilitating movement of the helical coils or other product dispensing mechanism therealong, and a roughened top surface 18, such as for providing friction to keep received products in a desired position.

The vending shim 10 according to the present invention thus provides a vendor with the ability to make a non-permanent modification to a vending machine. A vending machine may be retrofit by removably installing the shim 10 in a desired number of product dispensing lanes at one point in time, and that number may be easily modified should the vendor's needs change at another point in time. Thus, the vending shim 10 according to the present invention provides the vendor with great flexibility in configuring product dispensing lanes to dispense standard or non-standard products, such as bottles. Furthermore, the vending shim 10 according to the present invention does not require connection to the motor for activating the dispensing mechanism, nor does it require removal or replacement of the existing dispensing mechanism.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A shim for use with a vending machine having a housing and at least one dispensing mechanism for dispensing products, the shim comprising:
at least two spaced arms each having a first end and a second end, the arms capable of supporting products to be dispensed; and
a transverse member joining the arm second ends, wherein the transverse member is arranged to be attached to the housing such that the arms are disposed in proximity to the at least one dispensing mechanism for dispensing products.

2. The shim according to claim 1, wherein the transverse member further comprises an upstanding portion.

3. The shim according to claim 2, wherein the upstanding portion includes an adhesive material on a rear surface thereof for removably adhering the shim to the housing.

4. The shim according to claim 1, wherein the products to be dispensed are bottles.

5. The shim according to claim 4, wherein the bottles include packaging having a width greater than a distance between the arms.

6. The shim according to claim 1, wherein the arms are sized to extend substantially along a length of the at least one dispensing mechanism and be supported thereon.

7. The shim according to claim 1, wherein the arms have a thickness of approximately 1-3 mm.

8. The shim according to claim 1, wherein the shim is constructed from a plastic material.

9. A shim for use with a vending machine having a housing and at least one helical coil for dispensing products, the shim comprising:
a generally U-shaped, symmetric body having a pair of elongated arms each having a first end and a second end, the arms spaced apart to define an opening therebetween, the arms sized to extend substantially along a length of the at least one helical coil and capable of supporting products to be dispensed, and a transverse member joining the arm second ends, wherein the transverse member is arranged to be attached to the housing such that the arms are disposed in proximity to the at least one helical coil for dispensing products.

10. A method for supporting products to be dispensed from a vending machine having a housing and at least one dispensing mechanism, the method comprising:
providing a shim having at least two spaced arms each having a first end and a second end and capable of supporting products to be dispensed; and
attaching the shim to the housing such that the arms are disposed in proximity to the at least one dispensing mechanism.

11. The method according to claim 10, further comprising loading products into the vending machine so as to be supported by the arms and received at least partially within the at least one dispensing mechanism.

12. The method according to claim 11, wherein loading products includes loading bottles including packaging having a width greater than a distance between the arms.

13. The method according to claim 11, wherein loading products to be supported by the arms occurs prior to attaching the shim to the housing.

14. The method according to claim 11, wherein attaching the shim to the housing occurs prior to loading products.

15. The method according to claim 10, further comprising activating the at least one dispensing mechanism to advance products past the arm first ends in order to dispense products from the vending machine.

16. The method according to claim 10, wherein the shim includes a transverse member joining the arm second ends, and wherein attaching the shim includes attaching the transverse member to the housing.

17. The method according to claim 10, wherein the arms are sized to extend substantially along a length of the at least one dispensing mechanism, and attaching the shim to the housing further comprises disposing a bottom surface of the shim in contact with the at least one dispensing mechanism.

18. The method according to claim 10, wherein the at least one dispensing mechanism includes at least one helical coil.

19. The method according to claim 18, wherein the at least one helical coil includes two spaced helical coils, and attaching the shim includes positioning each arm along one of the coils.

20. A method for retrofitting a vending machine having a housing and at least one helical coil to dispense products having a base with a width less than a width of the at least one helical coil, the method comprising:
providing a shim having at least two spaced arms each having a first end and a second end, and a transverse member joining the arm second ends;
attaching the transverse member to the housing such that the arms are in proximity to the at least one helical coil; and
loading products into the vending machine so as to be supported by the arms and received at least partially within the at least one helical coil.
